(19) United States
(12) Patent Application Publication
(10) Pub. No.: US 2006/0137663 A1
(43) Pub. Date: Jun. 29, 2006

(54) Apparatus for separating entrained air from a liquid

(76) Inventor: Shawn Vaught, Jefferson City, MO (US)

Correspondence Address: DUANE MORRIS LLP, PO BOX 5203, PRINCETON, NJ, 08543-5203, US

(21) Appl. No.: 11/025,103

(22) Filed: Dec. 29, 2004

(51) Int. Cl. F02M 37/20; B01D 19/00

(52) U.S. Cl. 123/516; 96/220

(57) ABSTRACT

An apparatus for separating entrained air from a liquid includes a chamber extending vertically and having a bottom end and a dome-shaped top end. A divider is provided within the chamber dividing the chamber into an intake cavity and an exit cavity. The divider also forms a passage way near the top end of the chamber connecting the intake cavity and the exit cavity. The liquid enters the intake cavity through an inlet which has a smaller cross-sectional area than the intake cavity. The resulting increase in the liquid's volume causes pressure drop, in turn, causing the entrained air to coalesce into larger air bubbles and rise to the top of the liquid. As the liquid flows through the passage way, the separated air escapes through a bleed hole provided in the top end of the chamber.

### FIELD OF THE INVENTION

The present invention relates to the technology of separating and removing entrained air from a liquid.

### BACKGROUND

There is a need in certain technologies to separate entrained air from a liquid such as fuel, blood, water, etc. for a variety of reasons. For example, in internal combustion engines, diesel engines for example, air entrained in the fuel being delivered to the engine is not desirable. Most of the existing solutions for removing entrained air from liquids are not sufficiently efficient in removing the entrained air or sometimes may cause cavitation. Accordingly, an improved device and method of removing entrained air from a liquid is desired.

### SUMMARY OF INVENTION

According to an embodiment of the invention, an apparatus for separating entrained air from a liquid comprises an elongated air separating chamber extending vertically and having a bottom end and a top end. A divider is provided within the chamber dividing the chamber longitudinally into an intake cavity for receiving a liquid and an exit cavity from which the liquid exits the chamber. The divider also forms a passage way connecting the intake cavity and the exit cavity. The space between the divider and inner surface of the top end of the chamber defines the passage way. An inlet for receiving the liquid is provided in the intake cavity side of the chamber apart from the top end. An outlet for egress of the liquid from the exit cavity is provided in the exit cavity side of the chamber apart from the top end. A bleed hole, through which the separated entrained air is removed, is provided in the top end of the chamber near the passage way. The intake cavity has a larger cross-sectional area than the inlet so that as the liquid enters the intake cavity, its volume expands and as a consequence, the pressure of the flowing liquid decreases, causing the entrained air to coalesce into larger air bubbles and separate from the liquid. Because the inlet is spaced apart from the top end of the chamber, where the bleed hole is, the liquid has to travel some distance through the intake cavity to reach the bleed hole in the top end of the chamber. This provides some predetermined time for the air bubbles to coalesce to an optimal level. As the liquid flows from the intake cavity to the exit cavity through the passage way, the air bubbles rise to the surface of the liquid and exit through the bleed hole. The top end of the chamber may have a dome or dome-like shape with the bleed hole being provided at the peak of the dome-shaped top end so that the rising air bubbles collect near the bleed hole and exit.

According to another embodiment, an air separating apparatus may comprise one or more of the air separating chamber described above. If more than one air separating chambers are used, they may be connected in series or in parallel configuration as desired.

When more than one air separating chambers are used in series, the exit cavity side of the air separating chambers are configured similarly to the intake cavity side. For example, similar to the relationship between the inlet and the intake cavity, the outlet provided in the exit cavity side preferably has a smaller cross-sectional area than the exit cavity. Thus, as the liquid flows past the bleed hole in the passage way and downward in the exit cavity and out the constricted outlet, the Venturi effect will increases the flow pressure of the liquid and its flow speed through the outlet, which is the inlet of the next air separating chamber in the multiple air separating chambers that are connected in series. Thus, the air separating process is repeated in the next air separating chamber.

According to another embodiment, a fuel delivery system for separating and removing entrained air from a liquid fuel being supplied to an engine is disclosed. The fuel delivery system comprises a body having a fuel input port for receiving the fuel from a fuel tank, a fuel output port for directing the fuel to the engine, a fuel return input port for receiving excess fuel from the engine, and a fuel return output port for returning the excess fuel to the fuel tank. A fuel return passage connects the fuel return input port and the fuel return output port.

The fuel delivery system also includes at least one air separating chamber for separating and removing entrained air from the fuel. The chamber is provided between the fuel input port and the fuel output port. The chamber's structure is as described above in reference to the first embodiment of the invention, the apparatus for separating and removing entrained air from a liquid. The chamber's inlet is connected to the fuel input port and the chamber's outlet is connected to the fuel output port. The bleed hole of the chamber is connected to the fuel return passage so that the entrained air removed from the fuel through the bleed hole is returned to the fuel tank along with the excess fuel from the engine. The fuel output port returns the excess fuel returning from the engine and the air that has been removed from the fuel being supplied to the engine back to the fuel tank. In an embodiment of the fuel delivery system where more than one air separating chambers are provided, the chambers may be connected to each other in series or in parallel configuration as desired. If connected in series, the first air separating chamber's inlet is connected to the fuel input port and the outlet of the last air separating chamber is connected to the fuel output port.

According to another aspect of the invention, a device including one or more of the air separation chamber described above may be used in a medical application to remove entrained air from blood during surgery. Such device would comprise the same structural elements as the air separation chambers described above and blood would flow through the chamber to separate and remove entrained air from the blood.

According to the invention, the air separation chamber described above can be implemented in a variety of applications to remove entrained air from a variety of liquids such as, any biological fluid other than blood, all types of liquid fuels, such as crude oil, ethanol, diesel, biodiesel, gasoline, jet fuel, hydraulic fluids, extruded marble, polymer composites, molten glass, and plastics, etc. The particular dimensions of the air separation chamber and the chamber components for each of these applications would depend on the characteristics such as the viscosity of each liquid involved and the variety of dimensions of the air separation chambers are all within the scope of the various embodiments of the invention.

### BRIEF DESCRIPTION OF THE DRAWINGS

All drawings are schematic and are not intended to show dimensional information. Like reference numbers used in the drawings represent like elements.

FIGS. 1A-1F are various schematic sectional illustrations of an embodiment of the invention.

FIGS. 1G and 1H are examples of different configurations for the embodiment of the invention of FIGS. 1A-1F.

FIG. 2 is an isometric exploded view of a fuel delivery system according to another embodiment of the invention.

FIGS. 3 and 4 are sectional views of the fuel delivery system of FIG. 2.

FIG. 5A is a side plan view of a divider according to an embodiment.

FIG. 5B is a front plan view of the divider of FIG. 5A.

FIG. 5C is an isometric view of the divider of FIG. 5A.

FIG. 5D is a bottom plan view of the divider of FIG. 5A.

FIGS. 6A and 6B are side plan view and isometric views of a high-pressure bypass valve used in the fuel delivery system of FIG. 2.

FIG. 7 is an illustration of a parallel configuration of the air separating chambers of the fuel delivery system of FIG. 2 according to another embodiment.

### DETAILED DESCRIPTION OF THE INVENTION

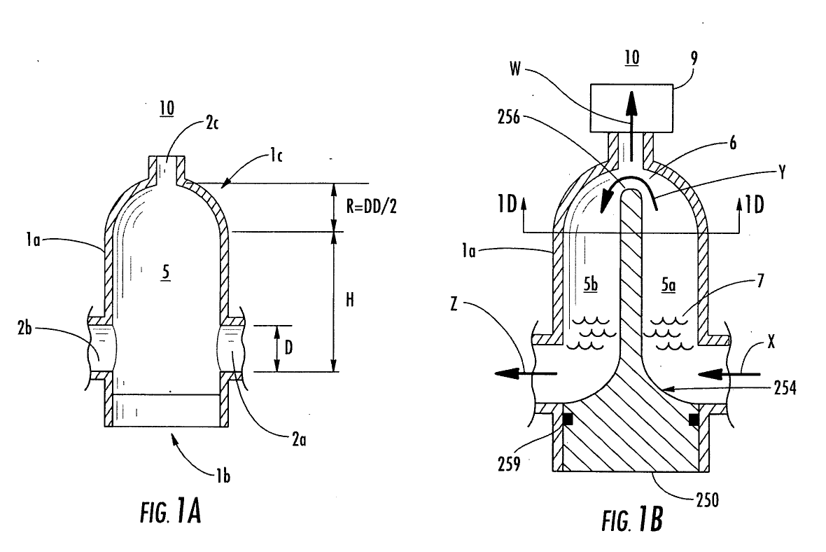

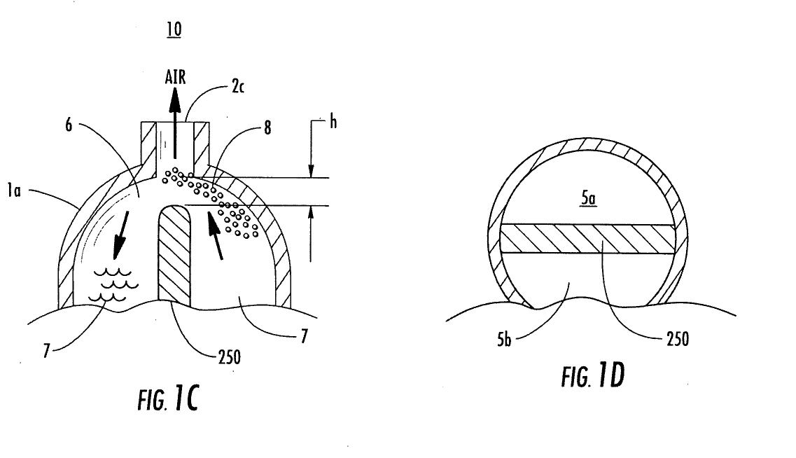

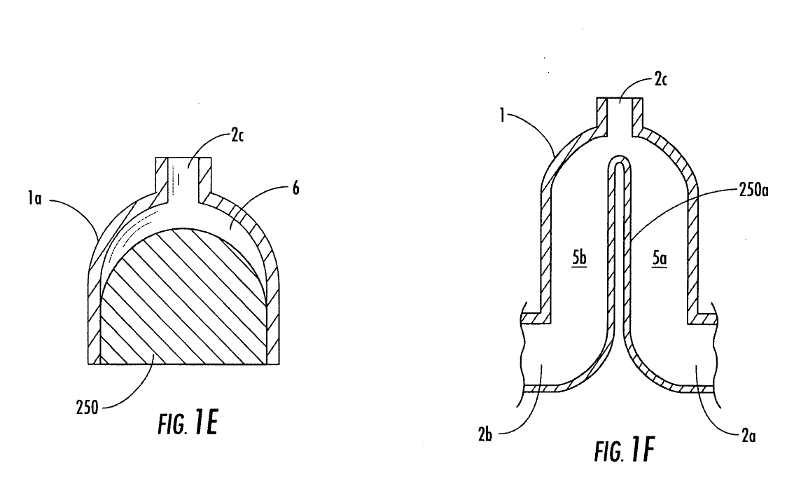

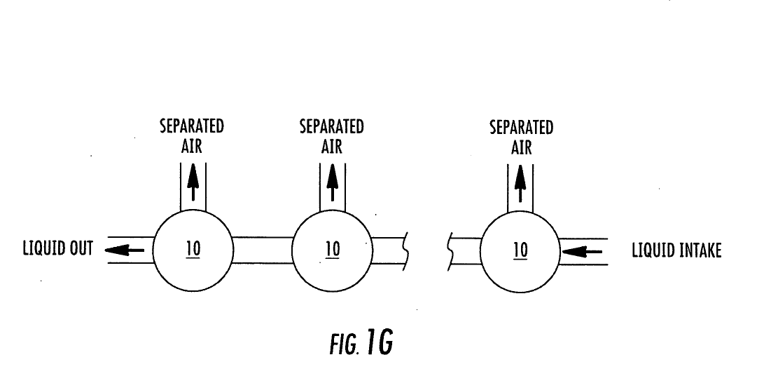

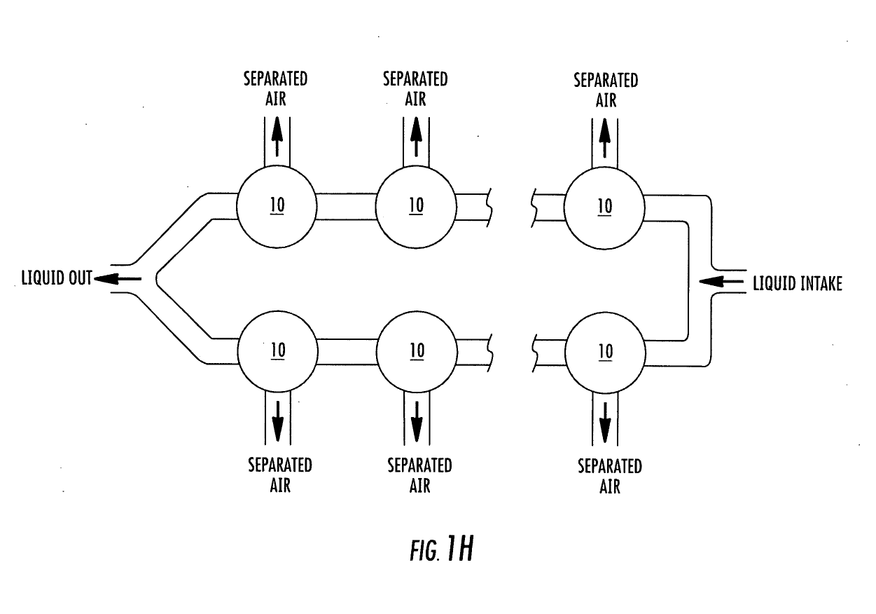

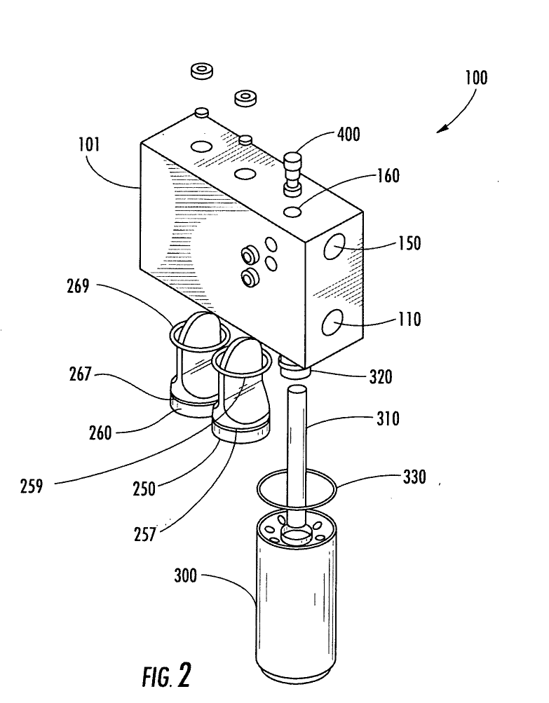

Referring to FIGS. 1A and 1B an embodiment of an apparatus 10 for separating entrained air from a liquid is disclosed. The apparatus 10 comprises a chamber body 1a defining a chamber 5 therewithin. The chamber 5 extends vertically and has an open bottom end 1b and a top end 1c. In this particular example, the chamber 5 has a substantially cylindrical shape and the top end 1c is dome-shaped. Provided within the chamber 5 is a divider 250 dividing the chamber 5 longitudinally into an intake cavity 5a and an exit cavity 5b. The divider 250 is introduced into the chamber 5 through the open bottom end 1b sealing the open bottom end 1b. The divider 250 also forms a passage way 6 connecting the intake cavity 5a and the exit cavity 5b. The space between the divider 250 and the inner surface of the top end of the chamber 5 defines the passage way 6. An inlet 2a for receiving the liquid is provided in the intake cavity side of the chamber 5 apart form the top end 1c. An outlet 2b for egress of the liquid from the exit cavity 5b is provided in the exit cavity side of the chamber 5, also apart from the tope end 1c. A bleed hole 2c is provided in the dome-shaped top end 1c of the chamber 5 near the passage way 6, through which the entrained air is removed.

The divider 250 in this exemplary apparatus 10 is provided as a separate piece that is fitted into the open bottom end 1b of the chamber 5 but it should be noted that in another embodiment, the divider structure 250 may be provided in a variety of different ways. For example, as illustrated in FIG. 1F, in another embodiment, the divider structure 250a may be formed out of the chamber body 1a as an integrated structure.

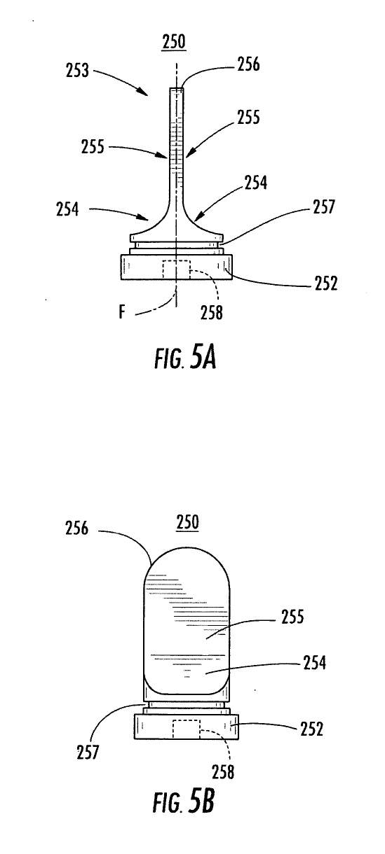

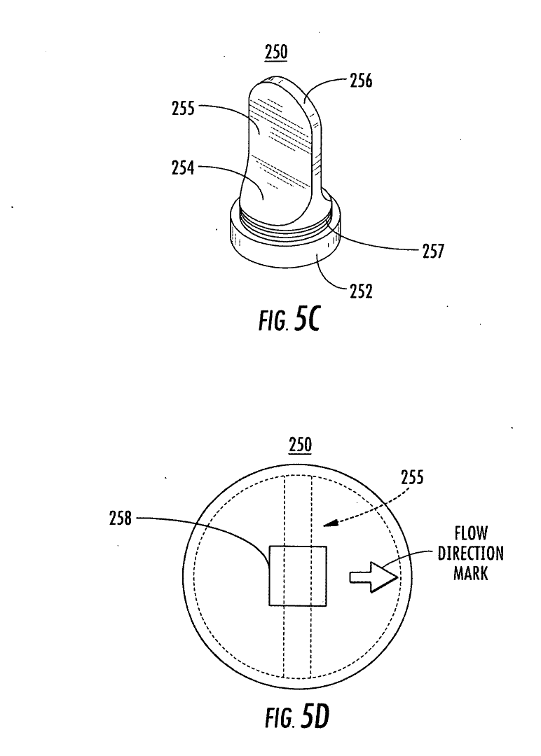

The structure of the divider 250 used in this embodiment is illustrated in FIGS. 5A-5C. As illustrated in FIGS. 5A, when viewed from side, the divider 250 is symmetric about its frontal plane F. The divider 250 comprises a base portion 252 and an upper portion 253. The upper portion 253 comprises a wall portion 255 and a transition portion 254 on each of the symmetric halves defined by the frontal plane F. Each of the transition portion 254 is curved to redirect the flow of the liquid in their respective intake cavity 5a or the exit cavity 5b without cavitating the liquid. Referring to FIG. 1B, which is a cross-sectional view of the apparatus 10 taken in a plane transverse to the wall portion 255 of the divider 250, liquid 7 which enters the intake cavity 5a through the inlet 2a, represented by the arrow X, would be directed upwards by the transition portion 254 of the divider 250. The symmetry between the two halves defined by the frontal plane F is not a necessary feature in the air separating chamber's ability to separate the entrained air. But, the symmetry or substantial symmetry at least with respect to the dimensional relationship between the cross-sectional areas of the inlet 2a and the intake cavity 5a and the cross-sectional areas of the outlet 2c and the exit cavity 5b is helpful when more than one air separating chambers are arranged in series.

The liquid 7 travels up along the flat wall portion 255 then flows over the divider 250 through the passage way 6, represented by the arrow Y, into the exit cavity 5b. The curvature of the dome-shaped top end 1c directs the flow of the liquid 7 through the passage way 6 from the intake cavity 5a to the exit cavity 5b. In the exit cavity 5b, the liquid 7 travels downward following the flat wall portion 255 and is directed to the outlet 2b by the transition portion 254 and exits through the outlet 2b as represented by the arrow Z.

The base portion 252 is shape to fit the opening in the bottom end 1b of the chamber 5. For example, in this embodiment, the chamber 5 has a cylindrical shape and the opening at the bottom end 1b has a circular cross-section. To sealingly fit into the opening at the bottom end 1b of the chamber body 1a, the base portion 252 of the divider 250 has a circular footprint. The base portion 252 may be provided with a sealing channel 257 to accommodate a sealing gasket 259 (see FIG. 1B), such as an elastic o-ring, for sealingly fitting into the opening at the bottom end 1b. When the divider 250 is assembled into its position inside the chamber body 1a, the sealing gasket 259 forms a fluid-tight seal with the chamber body 1a. It should be noted that the fluid-tight seal between the base portion 252 and the chamber body 1a may be formed by a variety of other sealing methods and is not limited to this particular exemplary configuration.

In addition to forming the sealing fit between the base portion 252 and the chamber body 1a, the base portion 252 of the divider 250 and the open bottom end 1b of the chamber body 1a may be configured and adapted to securely engage one another. For example, the base portion 252 of the divider 250 and the mating inner surface of the open bottom end 1b of the chamber body 1a may be provided with screw threads. Thus, when assembling the air removal apparatus 10, the divider 250 would be inserted into the open bottom end 1b of the chamber body 1a and thread the base portion 252 into the chamber body 1a. As shown in the bottom plan view, FIG. 5D, the divider 250 may be configured and adapted to receive any one of a variety of tools such as screw drivers, hex drivers, etc. This is represented by a square hole 258 in this example. Further, as illustrated in FIG. 5D, some type of a flow direction marker may be provided on the bottom of the divider 250 so that the valve divider 250 can be oriented properly in the chamber 5 in relation to the inlet 2a and the outlet 2b.

As shown in the plan view FIG. 5B of the divider 250, and the sectional view shown in FIG. 1E, the top edge 256 of the divider 250 is curved. This curvature will be referred to hereinafter as the front profile of the top edge 256. The front profile substantially follows the curvature of the dome-shaped top end 1c of the chamber 5. As shown in FIG. 5A, a side view of the divider 250, the top edge 256 also has a curved or rounded side profile. The curved front profile and the side profile of the top edge 256 of the divider 250 minimizes turbulence in the liquid 7 as it flows over the divider 250 through the passage way 6 from the intake cavity 5a to the exit cavity 5b. Minimizing turbulence, in turn, minimizes any cavitation of the liquid 7 which interferes with the air removal function of the apparatus 10.

Referring to FIGS. 1B and 1C, the operation of the air removal apparatus 10 will be described. The liquid 7 first enters the intake cavity 5a through the inlet 2a. The liquid 7 at this point contains undesirable amount o entrained air. The intake cavity 5a as defined by the divider 250 and the chamber body 1a, has a cross-section as shown in FIG. 1D. FIG. 1D is a sectional view of the air removing apparatus 10 through the line 1D-1D shown in FIG. 1B. The cross-sectional area of the intake cavity 5a between the inlet 2a and the passage way 6 is larger than the cross-sectional area of the inlet 2a. Thus, as the liquid 7 enters the intake cavity 5a, the volume of the liquid 7 expands, its flow speed slows down, and the flow pressure of the liquid 7 decreases. The pressure drop in the liquid 7 causes the entrained air to coalesce into larger air bubbles 8. And as the liquid 7 flows upwards towards the passage way 6, the buoyancy of air causes the air bubbles 8 to rise upwards. Because the inlet 2a is spaced apart from the top end 1c of the chamber 5, this provides some predetermined time for the air bubbles 8 to coalesce while the liquid 7 is flowing upwards towards the passage way 6. Thus, for a given fluid type, the intake flow speed of the liquid 7, the distance between the inlet 2a and the top end 1c, and the cross-sectional areas of the intake cavity 5a, the inlet 2a, and the passage way 6 are all interrelated variables that affects the efficiency of the apparatus 10 in removing entrained air from the liquid 7.

As the liquid 7 flows past the bleed hole 2c, the air bubbles 8 which have collected near the surface of the liquid 7 will leave the liquid and exit through the bleed hole 2c as represented by the arrow W. It should be noted that the bleed hole 2c may be configured and adapted so that its diameter may be adjusted as necessary to control the efficiency of the air removal. This may be accomplished by a variety of methods. One example is to use a cannulated screw threaded into the bleed hole 2c so that the cannula in the screw is the bleed hole. The size of the bleed hole can be changed by replacing the screw with one having a different diameter cannula.

As shown by the FIGS. 1D and 1E, the cross-sectional area of the flow path for the liquid 7 decreases between the intake cavity 5a and the passage way 6. This narrowing of the flow path in the passage way 6 enhances the removal of the air bubbles 8 from the liquid 7 by making the depth h of the liquid 7 underneath the bleed hole 2c smaller. Shallower depth h means that the air bubbles 8 have less distance to travel to rise to the surface of the liquid 7. The depth h can be controlled by changing the length of the divider 250 to control the efficiency of the air removal depending on the type of liquid involved.

The removal of the entrained air through the bleed hole 6 may be further enhanced by applying an optional suction force sufficient to draw the separated air but not strong enough to suck the liquid out of the chamber through the bleed hole 2c. This suction force may be provided by any appropriate means 9. Such suction providing means 9 may include devices, such as, an exhaust fan. This suction means 9 may be accomplished by connecting the bleed hole 2c to a pipe, tube, or a passage way of some kind that has a liquid or gas flowing through it at some sufficient velocity to create a suction in the bleed hole 2c. The liquid 7, now with much of its entrained air removed, flows downward in the exit cavity 5b and exits the apparatus 10 via the outlet 2b.

The principles of the air removal apparatus 10 can be applied to many different applications, such as removing entrained air from fuel for internal combustion engines and removing entrained air from blood in medical applications. Furthermore, the air removal apparatus 10 may be employed in any number and in any configuration as required by the demands of a particular application. For example, the apparatus 10 may be employed in multiple numbers connected in series, as illustrated in FIG. 1 G or in parallel configuration as illustrated in FIG. 1H.

The operational dimensions of a particular air removal apparatus are dependent upon the particular liquid involved. For example, a liquid having a higher viscosity requires longer time for the entrained air to coalesce to larger air bubbles and rise to the surface of the liquid. Thus, such liquid will require a chamber 5 with greater height H so that the intake cavity 5a is taller and the liquid has longer distance to travel from the inlet 2a to the passage way 6, providing longer time for the entrained air to coalesce into larger air bubbles. In one example of an air removal apparatus 10 used for removing entrained air from diesel fuel, the height H of the chamber 5 may be about four (4) times taller than the diameter D of the inlet 2a plus the radius R of the chamber diameter DD. The diameter DD of the chamber 5 is about 2⅓ times larger than the diameter D of the inlet 2a. As discussed above, the larger diameter DD of the chamber 5 provides that the cross-sectional area of the intake cavity 5a is larger than the cross-sectional area of the inlet 2a so that the speed of the liquid flowing into the intake cavity 5a is slowed down. For example, a ¾ inch diameter D inlet 2a would be used with a chamber 5 having a diameter DD of 1.75 inches. The chamber S would then have a height H of 3.875 inches (3 inches+0.875 inches).

The depth h of the liquid in the passage way 6 of the air removal apparatus 10 is preferably dimensioned so that the cross-sectional area of the passage way 6 at its narrowest point is about the same as the cross-sectional area of the inlet 2a. The diameter of the outlet 2b is also substantially same as the diameter D of the inlet 2a. This similarity of the cross-sectional areas of the inlet 2a, outlet 2b, and the passage way 6, prevents any restriction to the flow of the liquid through the air removal apparatus 10 for optimal operation of the air removal apparatus 10 and also makes the air removal apparatus 10 more universally acceptable to whatever the liquid flowing system into which the apparatus 10 might be inserted.

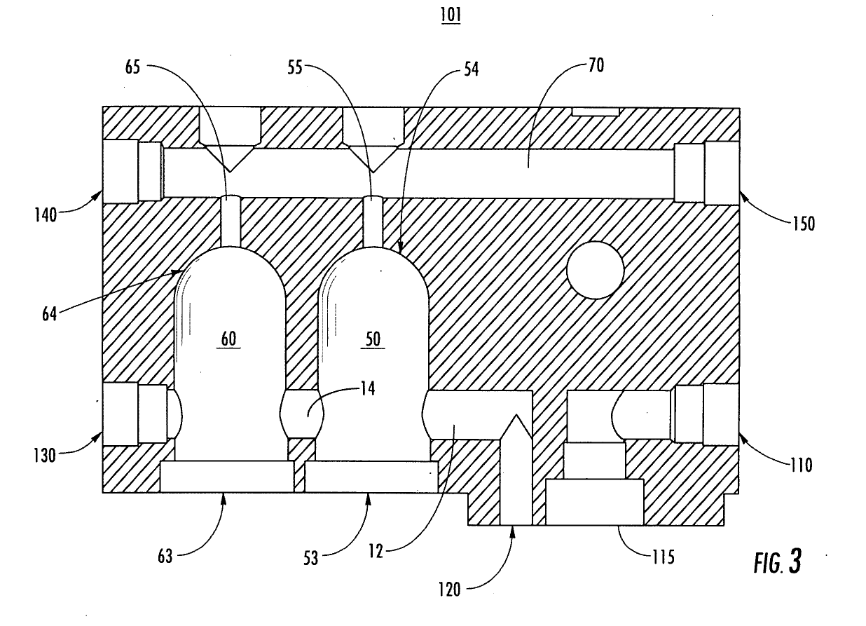

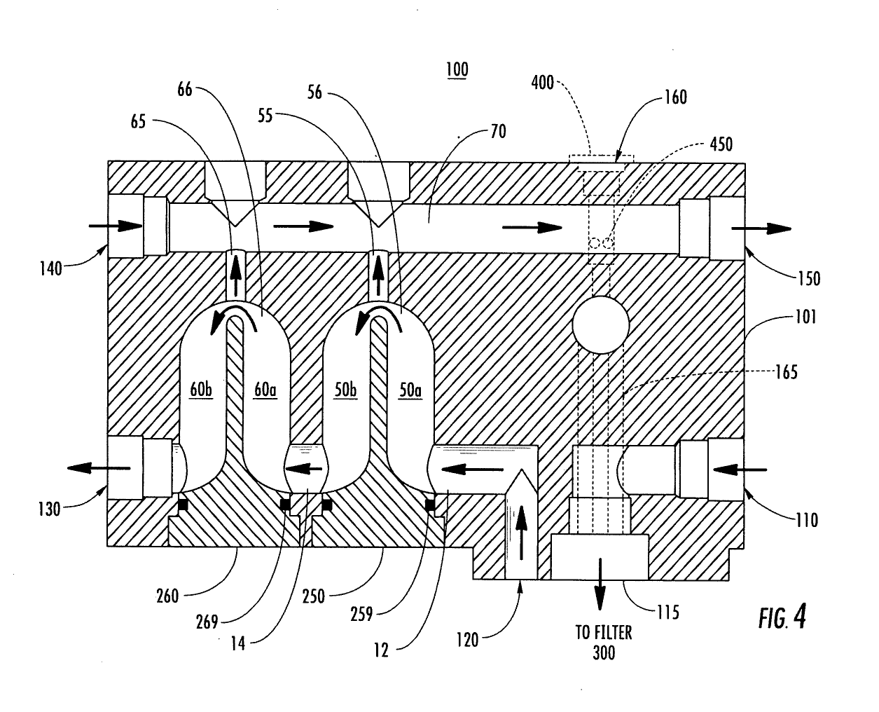

Referring to FIGS. 2-7B, a fuel delivery system 100 for internal combustion engines, such as a diesel engine, is disclosed. The fuel delivery system 100 comprises a body 101. The body 101 includes a fuel input port 110 for receiving fuel from the fuel tank (not shown), a fuel output port 130 (see FIGS. 3 and 4) for directing fuel to the engine (not shown), a fuel return input port 140 (see FIGS. 3 and 4) for receiving excess fuel from the engine, and a fuel return output port 150 connected to the fuel tank.

A fuel return passage 70 connects the fuel return input port 140 and the fuel return output port 150. The fuel delivery system 100 also includes one or more air separating chambers for separating and removing entrained air from the liquid fuel. The air separating chambers are configured and operates substantially similar to the air separating apparatus 10 described above. The actual number of air separating chambers provided in the fuel delivery system 100 will depend on the particular dimensions of the air separating chambers, which would affect the air removal capacity of a given air separating chamber and the particular air removal demand of a particular engine. But it should be noted that one or more air separating chambers may be employed and more than one air separating chambers may be configured in series, as shown in the embodiment illustrated in FIGS. 2-4, or in parallel configurations, as illustrated in FIG. 7, to meet the demands of a given application. In FIG. 7, some of the structural details, such as, for example, the bleed holes 55, 65, and the fuel return passage 70 are assumed to be present but not shown for simplicity.

In the exemplary embodiment of the fuel delivery system 100 illustrated in FIGS. 2-4, two such air separating chambers 50, 60 are provided. Referring to the sectional view of the body 101 of the fuel delivery system 100 illustrated in FIG. 3, the first air separating chamber 50 is configured to have a substantially cylindrical shape with an open bottom end 53 and a dome-shaped top end 54. A divider 250, as previously described in conjunction with the air separating apparatus 10, is inserted through the open bottom end 53 with the flat wall portion 255 first to achieve the assembled configuration as illustrated in FIG. 4. The base portion 252 of the divider 250 may threadably engage with the open bottom end 53 of the chamber 50 via screw thread that may be provided on the base portion 252 and the inner surface of the open bottom end 53. An elastomer o-ring 259 provides a fluid-tight sealing between the base portion 252 of the divider 250 and the inner surface of the open bottom end 53.

The divider 250 divides and defines the chamber 50 into an intake cavity 50a and an exit cavity 50b. The divider 250 also forms a passage way 56 connecting the intake cavity 50a and the exit cavity 50b. An inlet 12 for receiving the liquid fuel is provided in the intake cavity side of the chamber 50 near the bottom end 53. An interchamber passage 14 functioning as the outlet for egress of the liquid fuel from the exit cavity 50b is provided in the exit cavity side of the chamber 50, also near the bottom end 53. A bleed hole 55 is provided in the dome-shaped top end 54 of the chamber 50 near the passage way 56, through which the entrained air is removed.

The structure of the second air removal chamber 60 is same as the first chamber 50 with the same analogous structural components. The chamber 60 has an elongated cylindrical shape having an open bottom end 63 and a dome-shaped top end 64. The interchamber passage 14 functions as the inlet for the second chamber 60 and the fuel output port 130 is the outlet for the second chamber 60. A second divider 260 is provided within the second chamber 60 dividing and defining the second chamber 60 into an intake cavity 60a and an exit cavity 60b, and a passage way 66 connecting the intake cavity 60a and the exit cavity 60b. A bleed hole 65, through which the entrained air is removed from the liquid fuel passing through the passage way 66, is provided in the dome-shaped top end 64 of the second chamber 60 near the passage way 66.

The operation of the air separating chambers 50 and 60 with respect to the removal of entrained air from liquid fuel sent through each of these two air separating chambers 50, 60 is same as the operation of the air separating apparatus 10 described above. Referring to the sectional view illustrated in FIG. 4, the liquid fuel flows into the intake cavity 50a from the inlet 12 and flows through the passage way 56 to the exit cavity 50b. As the liquid fuel flows through the passage way 56 the entrained air that has coalesced into larger air bubbles rise to the top surface of the liquid fuel underneath the bleed hole 55 and escapes through the bleed hole 55. In the fuel delivery system 100, the liquid fuel is then sent through a second air separating chamber 60 that is serially connected to the first air separating chamber 50 to further remove any residual entrained air from the liquid fuel. The liquid fuel leaves the exit cavity 50b and enters the intake cavity 60a of the second chamber 60 through the interchamber passage 14. The liquid fuel, then, flows through the passage way 66 to the exit cavity 60b of the second chamber 60. As the liquid fuel flows through the passage way 66 any additional entrained air that has coalesced into larger air bubbles rise to the top surface of the liquid fuel underneath the bleed hole 65 and escapes through the bleed hole 65.

The liquid fuel which has been rid of much of its entrained air exits the fuel delivery system 100 through the fuel output port 130 and delivered to the engine. Any unused excess fuel from the engine is returned to the fuel delivery system 100 via the fuel return input port 140 passes through the fuel return passage 70 and exits through the fuel return output port 150 and back to the fuel tank. According to an aspect of the invention, the bleed holes 55 and 65 of the air separating chambers 50 and 60, respectively, exhaust into the fuel return passage 70. This configuration enhances the removal of the air that has been separated from the liquid fuel because the returning excess fuel that is flowing through the fuel return passage 70 creates a low pressure condition as it passes by the bleed holes 55 and 65. This low pressure creates suction and enhances the removal of the separated air from each of the air separating chambers 50 and 60. For most diesel engines, the velocity of the excess fuel flowing in the fuel return passage 70 generated by the natural combustion operation of the engine is high enough to generate sufficient pressure drop at the bleed holes 55 and 65. If the velocity of the excess fuel is not high enough, it may be boosted by any appropriate methods known in the art, such as using a booster pump.

In one embodiment of the fuel delivery system 100, the fuel input port 110 may be directly connected to the inlet 12 of the first air separating chamber 50. The liquid fuel from the fuel tank (not shown) would enter the fuel input port 110 and fed directly into the first air separating chamber 50. If the liquid fuel needs to be filtered to remove particular contaminants before being delivered to the engine, which is generally the case, the liquid fuel may be filtered before reaching the fuel delivery system 100.

In another embodiment of the fuel delivery system 100, a fuel filtration arrangement may be incorporated into the fuel delivery system 100. This embodiment is illustrated in the FIGS. 2-4 and 7. As illustrated in FIG. 2, a fuel filter 300 may be provided with the fuel delivery system 100 to filter the liquid fuel before the fuel reaches the first air separation chamber 50. The fuel filter 300 is secured to the fuel delivery system body 101 by a connector 320. The fuel flows into the filter through the filter tube 310. An elastomer o-ring 330 may be used to provide a fluid-tight seal between the filter 300 and the fuel delivery system body 101.

The flow of the liquid fuel in that embodiment is shown in FIG. 4. The fuel enters through the fuel input port 110 and directed to the filter 300, which is secured to the fuel delivery system body 101, by a passage 115. The filtered fuel from the filter 300 returns to the fuel delivery system body 101 via a second fuel input port 120 which is connected to the inlet 12 of the first air separating chamber 50.

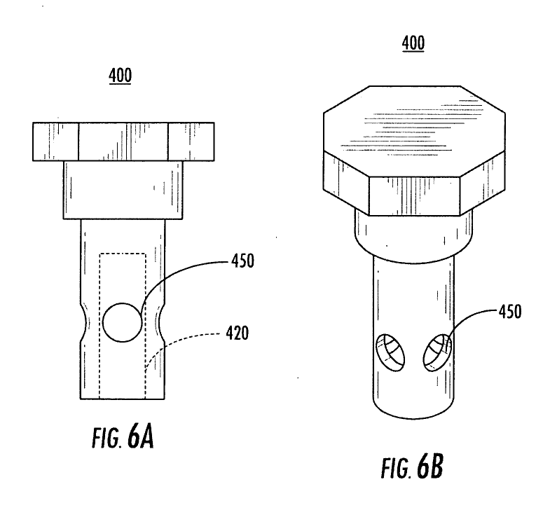

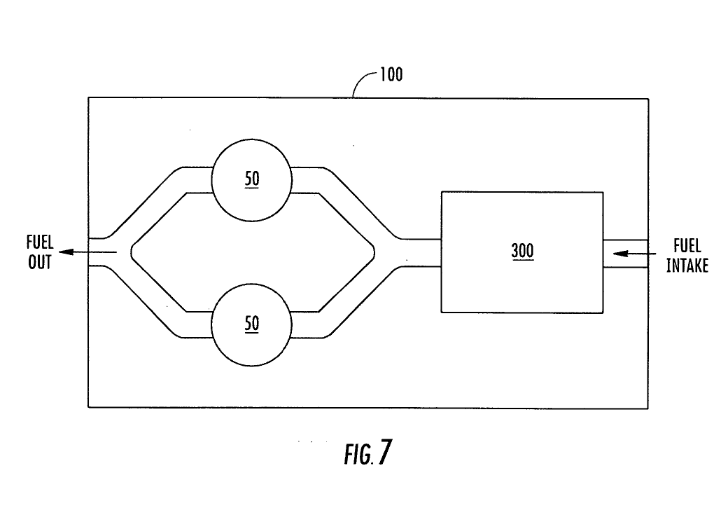

In the embodiment of the fuel delivery system 100 in which the fuel filter 300 is provided may also include a high-pressure bypass valve 400. In the event that any blockage or flow restriction occurs downstream from the fuel delivery system 100, the resulting pressure increase in the fuel delivery system is alleviated by the high-pressure bypass valve 400. The bypass valve 400 is shown in FIGS. 6A and 6B. The bypass valve 400 comprises a cavity 420 that opens to the bottom and a plurality of bypass openings 450 connected to the cavity 420. The high-pressure bypass valve 400 is provided in a hole 160 in the fuel delivery system body 101 as illustrated in FIG. 2. The position of the bypass valve 400 is further illustrated in the sectional view of FIG. 4 by broken lines outlining the position of the bypass valve 400 and a bypass passage 165. The bypass passage 165 connects the passage 115 on the input side of the filter 300 to the cavity 420 of the bypass valve 400. And the bypass valve 400 is positioned so that the bypass openings 450 are in communication with the fuel return passage 70.

In normal operation, the liquid fuel on the input side of the filter 300 fills up the passage 115, the bypass passage 165 and the cavity 420 but the fuel is under a static pressure. When a blockage or a restriction downstream from the fuel delivery system 100 occurs and the pressure of the liquid fuel in the system increases above a predetermined level, the bypass valve 400 opens allowing the fuel to flow through the bypass valve's cavity 420 and exit through the bypass openings 450 into the fuel return passage 70. The pressure limit on the bypass valve 400 is set to the particular pressure requirements of the particular engine and fuel system.

The dividers 250, 260 may be provided as separate pieces that are fitted into the body 101 as illustrated in the exemplary fuel delivery system 100, or they may be fabricated and provided as structures that are integrated into the body 101.

All of the structural components described herein with respect to the invention would be made of materials that are compatible with the particular liquid involved and the final application environmental conditions. For example, in the embodiment for separating entrained air from liquid fuel such as diesel fuel or gasoline, the structural components such as the fuel delivery system body 101 and the dividers 250, 260 may be made from aluminum alloy or other metallic or non-metallic materials that are compatible with diesel fuel or gasoline.

While the foregoing invention has been described with reference to the above, various modifications and changes can be made without departing from the spirit of the invention. Accordingly, all such modifications and changes are considered to be within the scope of the appended claims.

What is claimed is:

1. An apparatus for separating entrained air from a liquid comprising:
at least one chamber extending vertically and having a bottom end and a top end, the at least one chamber comprising:
a divider provided within the chamber dividing the chamber longitudinally into an intake cavity for receiving a liquid and an exit cavity from which the liquid exits the chamber;
a space between the divider and inner surface of the top end of the chamber defining a passage way connecting the intake cavity and the exit cavity;
an inlet provided in the intake cavity for ingress of the liquid, the inlet being spaced apart from the top end of the chamber, wherein the intake cavity has a larger cross-sectional area than the inlet;
an outlet provided in the exit cavity for egress of the liquid, the outlet being spaced apart from the top end of the chamber;
a bleed hole, through which the separated entrained air exits, provided in the top end of the chamber near the passage way.

2. The apparatus of claim 1, wherein the bottom end of the chamber is an open end and the divider is introduced into the chamber through the open bottom end sealing the open bottom end.

3. The apparatus of claim 1, wherein the divider has a base portion, a wall portion, and a transition portion between the base portion and the wall portion.

4. The apparatus of claim 1, wherein the chamber has an elongated shape.

5. The apparatus of claim 1, wherein the chamber has an elongated cylindrical shape and the top end is dome-shaped.

6. The apparatus of claim 1, wherein the exit cavity has a larger cross-sectional area than the outlet.

7. The apparatus of claim 1, further comprising a means for providing a suction to the bleed hole.

8. The apparatus of claim 1, further comprising a plurality of the air separating chambers, wherein the air separating chambers are connected in series configuration.

9. The apparatus of claim 1, further comprising a plurality of the air separating chambers, wherein the air separating chambers are connected in parallel configuration.

10. The apparatus of claim 1, wherein the liquid is a fuel for an internal combustion engine.

11. The apparatus of claim 1, wherein the liquid is blood.

12. A fuel delivery system for separating entrained air from a liquid fuel being supplied to an engine, the system comprising:
a fuel input port for receiving the liquid fuel from a fuel tank;
a fuel output port for directing the liquid fuel to the engine;
a fuel return port for receiving excess fuel from the engine;
a fuel return output port for returning the excess fuel to the fuel tank;
a fuel return passage connecting the fuel return input port and the fuel return output port;
at least one air separating chamber provided between the fuel input port and the fuel output port, the air separating chamber extending vertically and comprising:
a bottom end and a top end;
a divider provided within the chamber dividing the chamber longitudinally into an intake cavity for receiving a liquid and an exit cavity from which the liquid exits the chamber;
a space between the divider and inner surface of the top end of the chamber defining a passage way connecting the intake cavity and the exit cavity;
an inlet provided in the intake cavity for ingress of the liquid, the inlet being spaced apart from the top end of the chamber, wherein the intake cavity has a larger cross-sectional area than the inlet;
an outlet provided in the exit cavity for egress of the liquid, the outlet being spaced apart from the top end of the chamber;
a bleed hole, through which the separated entrained air exits, provided in the top end of the chamber near the passage way, wherein the chamber's inlet is connected to the fuel input port and the chamber's outlet is connected to the fuel output port and the bleed hole is connected to the fuel return passage allowing the air exiting the bleed hole to mix with the excess fuel and returned to the fuel tank.

13. The system of claim 12, wherein the bottom end of the chamber is an open end and the divider is introduced into the chamber through the open bottom end sealing the open bottom end.

14. The system of claim 12, wherein the divider has a base portion, a wall portion, and a transition portion between the base portion and the wall portion.

15. The system of claim 12, wherein the chamber has an elongated shape.

16. The system of claim 12, wherein the chamber has an elongated cylindrical shape and the top end is dome-shaped.

17. The system of claim 12, wherein the exit cavity has a larger cross-sectional area than the outlet.

18. The system of claim 12, further comprising a plurality of air separating chambers provided between the fuel input port and the fuel output port, wherein the air separating chambers are connected in series configuration.

19. The system of claim 12, further comprising a plurality of air separating chambers provided between the fuel input port and the fuel output port, wherein the air separating chambers are connected in parallel configuration.
